(19) United States
(12) Patent Application Publication
(10) Pub. No.: US 2016/0123408 A1
(43) Pub. Date: May 5, 2016

(54) VISCOUS CLUTCH WITH HIGH-SPEED RESERVOIR AND BIMETAL STRIP MEMBER

(71) Applicant: BorgWarner Inc., Auburn Hills, MI (US)

(72) Inventors: Gerard M. Light, Marshall, MI (US); Darin Gwin, Marshall, MI (US); Mike Tuttle, Battle Creek, MI (US)

(21) Appl. No.: 14/530,735

(22) Filed: Nov. 1, 2014

(51) Int. Cl. F16D 35/02; F16D 47/06

(52) U.S. Cl. CPC F16D 35/022; F16D 47/06; F16D 2500/10468

(57) ABSTRACT

A viscous fan drive including a fluid valve activated by a bimetal strip member, and including a clutch disk member and fluid reservoir rotatable at input speed. The fluid reservoir is contained in a reservoir chamber member positioned on the clutch disk member. The bimetal strip member controls the operation of a valve member which in turn controls the passage of fluid into the working chamber for operation of a cooling fan.

### CROSS-REFERENCE TO RELATED APPLICATIONS

This application is related to U.S. patent application Ser. No. ______ entitled Viscous Clutch With High-Speed Reservoir and Bimetal Coil Member (DKT14067), and U.S. patent application Ser. No. ______ entitled Viscous Clutch With High-Speed Reservoir, Valve in Housing, and Bimetal Member (DKT14218), both filed on the same day as the present application.

### TECHNICAL FIELD

The present invention relates to viscous clutch fan drives, and more particularly to viscous clutch fan drives with high-speed fluid reservoirs and bimetal valve activation.

### BACKGROUND

The great majority of vehicles utilize engines run on an organic fuel, such as gasoline. Engine driven cooling fans are used to assist in cooling the engines and engine accessories. There are several types of cooling fan drives in use today, including dry friction clutch drives, wet friction clutch drives, and viscous clutch fan drives.

Due to the need for vehicles to meet restrictive mileage and emission standards, various improvements have been made relative to the components, structures and control of the drives for cooling fans. Viscous fluid clutches, in particular, which provide precise control of the operation and speed of the fans, have been used successfully to assist in meeting these standards.

The principal types of viscous clutch drives used to control the operation and speed of the cooling fans, are those with either electromagnetic-type valves or bimetal-type valves. These valves meter the amount of viscous fluid which can flow into the working chambers and thus can regulate the speed of the cooling fans.

### SUMMARY OF THE INVENTION

The present invention relates to improved viscous fluid clutch fan drives with bimetal control of the valve mechanisms. The viscous clutch drives have a housing, a cooling fan, a bimetal mechanism, a valve operated by the bimetal mechanism, a fluid reservoir for the viscous fluid, a working chamber and a scavenge system. In some embodiments, the fluid valve mechanism, clutch disk member, and fluid reservoir are rotated at input speed by a pulley member, while the housing, cooling fan, and scavenge system all rotate at fan speed. Input speed also can be referred to as “high speed”. In other embodiments, the fluid valve mechanism can be included as part of the housing.

In one embodiment, the bimetal mechanism includes a bimetal coil member positioned external to the housing and positioned in operable contact with a rotatable valve member which controls the operation of fluid ports in the housing. Movement of the bimetal strip member caused by temperature changes, rotates the valve member and controls the amount of viscous fluid which can flow into the working chamber. A wiper member returns the fluid to the scavenge system where it returns to the fluid reservoir.

In another embodiment, the bimetal mechanism includes a bimetal strip member. The bimetal strip member is positioned external to the housing and is connected to an axial moveable fluid valve member inside the housing. Bending of the bimetal strip member due to temperature changes, moves the fluid valve member axially and controls the amount of viscous fluid which can flow into the working chamber. A wiper member returns the fluid to the scavenge system where it returns to the fluid reservoir.

In a further embodiment, a valve member is provided on the inside of the cover member and is activated by a bimetal coil member. The valve member closes and opens an exit port from a scavenge passageway. Scavenge fluid enters the fluid reservoir which is positioned on the clutch disk member and rotates with it at input speed. Fluid from the fluid reservoir flows directly to the working chamber and a wiper member returns the fluid to the scavenge passageway.

The bimetal mechanisms provide reliable control of the speed of the cooling fans. The high speed fluid reservoir increases the engagement response of the fan drive. This is particularly important at low fan speeds. Also, reducing the fan speed when the fan drive is disengaged results in lower parasitic losses and improves fuel economy.

Other objects, features, benefits and advantages of the invention will become apparent from the following description when viewed in combination with the attached drawings and appended claims.

### BRIEF DESCRIPTION OF THE DRAWINGS

FIG. 1 is a perspective view of one embodiment of the present invention.

FIG. 2 is a cross-sectional view of the embodiment shown in FIG. 1.

FIG. 3 is a schematic partial view of a portion of the cross-section shown in FIG. 2.

FIGS. 4 and 5 are plan views of a clutch disk which can be utilized in the embodiment shown in FIGS. 1-3.

FIG. 6 is a perspective view of another embodiment of the invention.

FIGS. 7 and 8 are cross-sectioned views of the embodiment shown in FIG. 6 illustrating the axially movement of the valve member.

FIGS. 9-11 illustrate still another embodiment of the invention.

### DESCRIPTION OF THE PREFERRED EMBODIMENTS

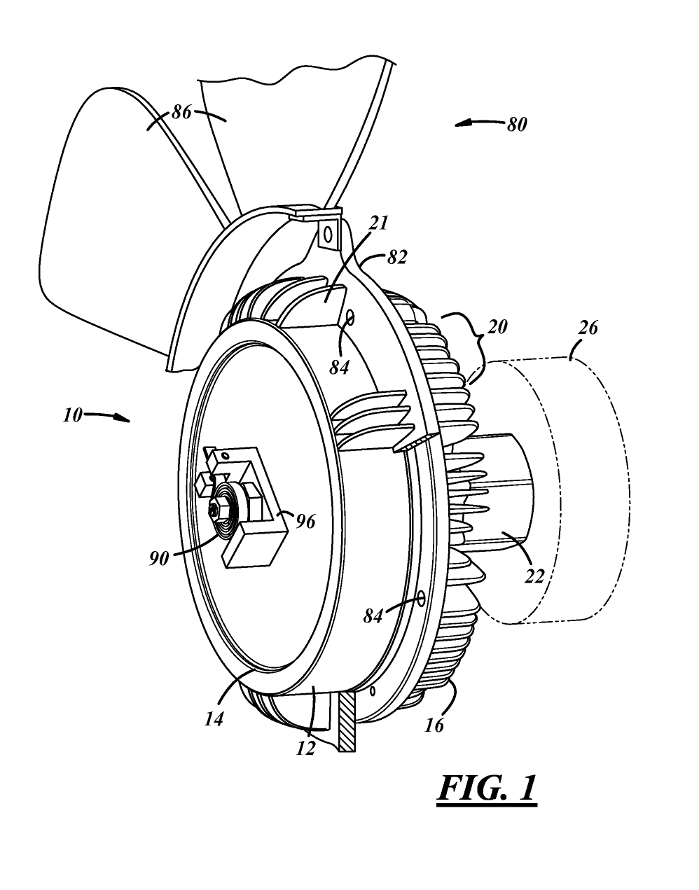

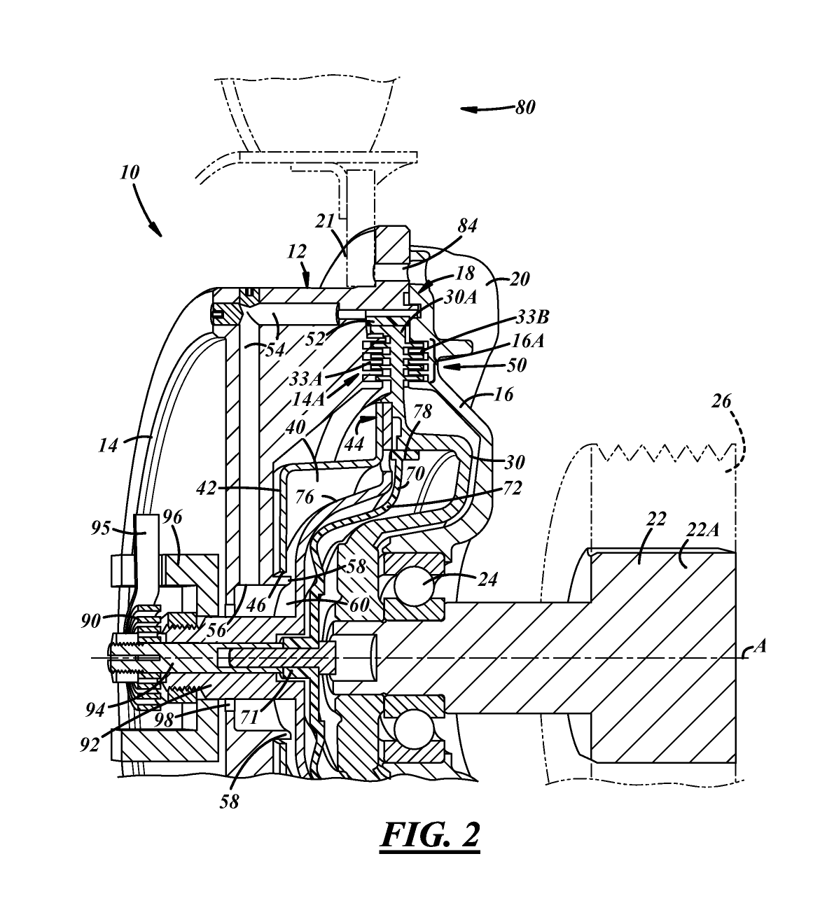

As shown in the drawings, the fan drive embodiment of the invention shown in FIGS. 1 and 2 is referred to by the number 10. The fan drive includes a housing 12 which includes a cover member 14 and a body member 16. The cover member and body member are fixedly connected together at an annular joint 18. The method of connection can be any of the conventional methods known today in connecting metal components together. The cover member 14 and body member 16 each have a plurality of cooling fins 21 and 20, to aid in dissipating heat generated by the viscous clutch. Preferably the cooling fins are positioned entirely around, or substantially around, the circumference of the cover and body members (only portions of the cooling fins are shown in the drawings.)

A fan member 80 is attached to the housing 12, as partially shown in FIG. 1. The fan member has a central annular hub member 82 which is attached to the cover member 14, such as, for example, by fasteners (not shown) positioned in openings 84 in the housing member. A plurality of fan blades 86 are attached to the hub member forming the cooling fan 80. In this embodiment, the cooling fan rotates with the housing 12. The diameter of the fan, as well as the number, size and shape of the fan blades, are dependent on the use of the viscous clutch and the size, power and type of vehicle in which the viscous clutch is to be utilized.

A shaft member 22 is positioned in the axial center A of the fan drive 10 (see FIG. 2). The housing 12 is rotatably positioned on the shaft member 22 by a bearing member 24. A pulley member 26 (shown in dashed lines) is fixedly secured to the shaft member at one end 22A. The pulley is rotated at input speed by a belt member (not shown) connected to another pulley or a transmission on the engine, such as a FEAD. This is a conventional way to rotate components of a viscous clutch fan drive, as well as other engine accessories. The size and shape of the depicted shaft member, and the positioning of the pulley member, are only exemplary.

A clutch disk member 30 is positioned inside the housing member 12. The clutch disk member is fixedly connected to the shaft member 22 and rotates with it at input speed. The clutch disk member is connected to the shaft member in any conventional manner, such as by force fit, keying and the like. A fluid chamber cover member 42 is fixedly connected to the clutch disk member 30 and rotates with it. The cover member 42 forms a fluid chamber 40.

The annular outer portion 30A of the clutch disk 30 has at least one, and preferably a pair, of labyrinths 33A and 33B of concentric ridges and grooves, one on each side of the outer portion 30A. Similarly, the cover member 14 and the body member 16 have corresponding labyrinths 14A and 16A which mate and interact with the labyrinths 33A and 33B on the clutch disk member. Mating labyrinths to operate viscous clutch fan drives are in common use today and any conventional type of labyrinths and portions of ridges and grooves can be utilized. Also, although two mating sets of labyrinths are shown in FIG. 2, it is understood that only one or more mating sets of labyrinths can be provided in accordance with the invention. The area where the labyrinths are positioned is called the working chamber. This is identified by the number 50 in FIG. 2.

It is also possible, as known in the art, to use other shearing members, such as configurations of ridges and grooves, or two smooth surfaces.

In order to remove viscous fluid from the working chamber, a wiper member 52 and a scavenge channel or passageway 54 are utilized. The wiper member 52 can be any of the conventional wiper members in use today, and preferably is a plastic device that is secured to a surface of the housing adjacent the clutch disk member and is positioned in the annular gap between the housing and the outer surface of the clutch disk member. The scavenge channel 54 is formed in the cover member 14 in any conventional manner, such as by drilling. The end or exit port 56 of the scavenge channel opens up into a central chamber 60 in the housing.

A valve member 70 is also positioned in the fluid reservoir or chamber 40. The valve member is operably connected to the shaft member 22 and rotates with it. The valve member 70 preferably has a central hub member 71 which is connected to the shaft member and a plurality of finger members (or spokes) 72 which extend radially outwardly. Preferably at least two finger members (or spokes) are provided. A valve carrier member 76 is positioned adjacent the valve member 70 and acts to support it. The valve carrier member 76 also rotates with the clutch disk member 30 and valve member 70. The valve support member has a plurality of openings 77 for passage of viscous fluid from one side of the fluid chamber 40 to the other.

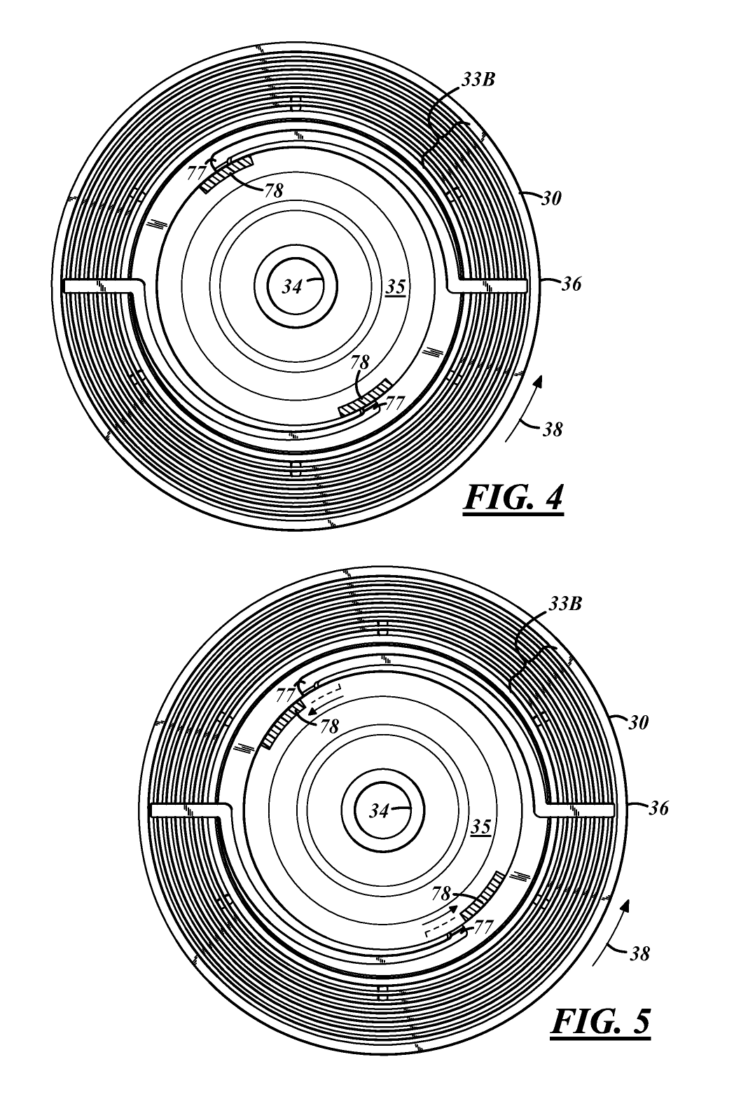

Flange members 78 are attached to the outer ends of the finger members (spokes) 72 of the valve member 70. As shown in FIGS. 4 and 5, the flange members 78 are positioned to operably open and close fluid ports 77 through which viscous fluid in the fluid chamber can be passed to the working chamber 50. In FIG. 4, the flange members 78 are positioned to close the fluid ports 77. In FIG. 5, the flange members 78 are positioned to allow the fluid ports 77 in the clutch disk member 30 to be open. The amount of rotation of the valve member 70 (caused by the bimetal coil member as explained below) controls the amount of rotation of the flange members 78 relative to the ports 77, which in turn regulates the amount of viscous fluid that can enter the working chamber, and the speed of the fan.

Also shown in FIGS. 4 and 5 is one of the labyrinths 33B on the valve disk member 30. As the viscous fluid enters the working chamber through ports 77, the fluid fills the grooves in all of the labyrinths that are present. Rotation of the clutch disk member 30 forces the viscous fluid radially outwardly and into the annular gap between the housing and clutch disk member, where the wiper member 52 forces the viscous fluid into the scavenge channel 54.

In an alternate embodiment, openings (not shown) can be provided in the flange members on the valve member. Rotation of the valve member then can position the openings into and out of alignment with the fluid ports 77 in the clutch disk member, thus opening and closing the fluid ports.

As indicated, the fluid chamber 40 is formed by use of the cup-shaped fluid chamber cover member 42. The chamber cover member is connected to the valve carrier member 76 which in turn is connected to the clutch disk member 30. The cover member 42 and carrier member 76 can be secured together and in place in any conventional manner, such as by folding over an upstanding annular ridge (not shown) on the clutch disk member.

The fluid chamber cover member 42 has a central opening 46. The viscous fluid is immediately directed from the exit port 56 of the scavenge channel 54 into the fluid reservoir 40 through the central opening 46. A drip lip 58 on the fluid cover member assists in directing the viscous fluid into the fluid reservoir.

The introduction of viscous fluid into the working chamber causes the housing 12 and fan member 80 to rotate. As conventional with viscous clutch drives, the amount of viscous fluid in the working chamber regulates the speed of the cooling fan and thus the amount of cooling air stream provided by the viscous fluid clutch fan drive 10.

The clutch disk member 30 is connected to the shaft member and has a central opening 34 that fits around the shaft member 22. The clutch disk member has an outer perimeter flat surface 36 and rotates in the direction as shown by the arrow 38 in FIGS. 4 and 5. The central area 35 of the clutch disk member is preferably a flat or planar surface and is the area where the fluid chamber cover is positioned and thus where viscous fluid is located in the fluid chamber 40.

A coil-type bimetal member 90 is positioned at the exterior of the cover member 14. The bimetal coil member contains two metal materials with different coefficients of expansion. When the bimetal coil member is heated, the coil contracts (deforms) and rotates. The higher the temperature, the more the coil contracts and rotates. In general, the amount of rotation of a coil-type bimetal member depends on the types of metal materials, the size of the coils forming the coil member, and the size of the coil itself.

Bimetallic members have been used to convert temperature changes into mechanical displacements. Bimetal members consist of two strips of different metals which expand at different rates as they are heated. The two different materials are typically steel and copper, or steel and brass. The two metal materials are joined together throughout their length, such as by riveting, brazing or welding. The differences in expansion of the two materials force the strip to expand or bend a certain way if heated. If the bimetal member is a strip, then the metal with the higher coefficient of thermal expansion is on the outer side of the curve when the strip is heated.

A bimetallic coil member essentially is a flat bimetallic strip member that is formed into a coil shape. It consists of two layers of metal material with different rates of thermal expansion and contracts radially, rather than bending one way or the other.

The valve member 70 has a cylindrical connection member 92 which is connected to, and rotates with the shaft member 22, valve disk member 30 and valve carrier member 76. Seal member 98 allows the valve connection member 92 to rotate and/or slide freely relative to the cover member 14. The coil member 90 is held in position by support member 96 and secures the end 95 of the bimetal coil 90 in position.

Central shaft member 94 of the bimetal coil member 90 rotates as the coil member heats up and rotates. The shaft member 94 is directly attached to the valve member 70 which causes the valve member to rotate with it. Thus, even as the coil member 90, valve member 70 and clutch disk member 30 rotate at input speed, the valve member 70 can independently also rotate as operated by the bimetal coil member.

When the bimetal coil member is heated, it rotates the valve member 70 and opens the passageway for fluid into the working chamber. When the bimetal coil member is not heated and cooling by the cooling fan is not needed, the openings into the working chamber 50 are closed. In this situation, the viscous fluid has been scavenged from the working chamber and returned to the fluid chamber, and very little viscous fluid remains in the working chamber.

The amount of viscous fluid which is allowed to pass into the working chamber governs the speed of the cooling fan. Thus, with this embodiment, the speed of the rotation of the cooling fan can go from near zero to full speed and anywhere in-between. The speed of the cooling fan is infinitely variable.

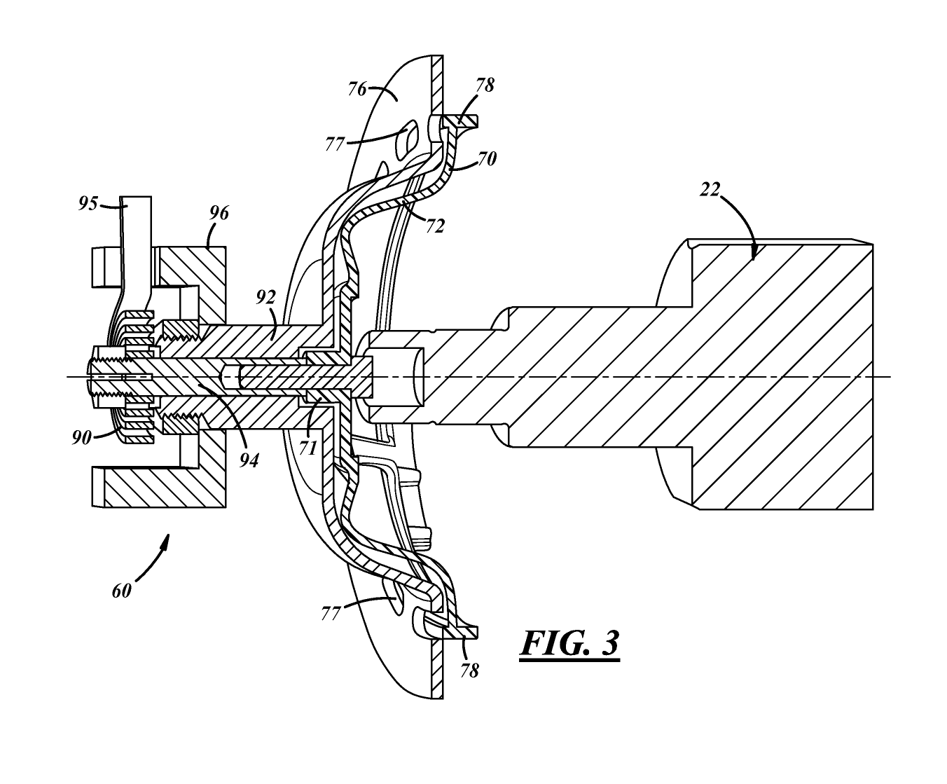

With the embodiment shown in FIGS. 1-5, a bimetal coil actuated viscous clutch fan drive is provided with a fluid reservoir 40 that rotates at input speed (“high speed”). The high speed fluid reservoir improves engagement response of the fan, especially at low fan speeds. Reducing the fan speed when the fan drive is disengaged results in lower parasitic losses. This in turn can improve fuel economy for the engine and vehicle.

As indicated, the wiper member 52 utilized with the embodiments in FIGS. 1-5 can be any type of conventional wiper member used in viscous clutch fan drives. The wiper member removes viscous fluid from the outer circumferential surface 36 of the clutch disk member 30 and directs it to the scavenge channel 54. This action creates pressure which pumps the fluid into and through the scavenge channel.

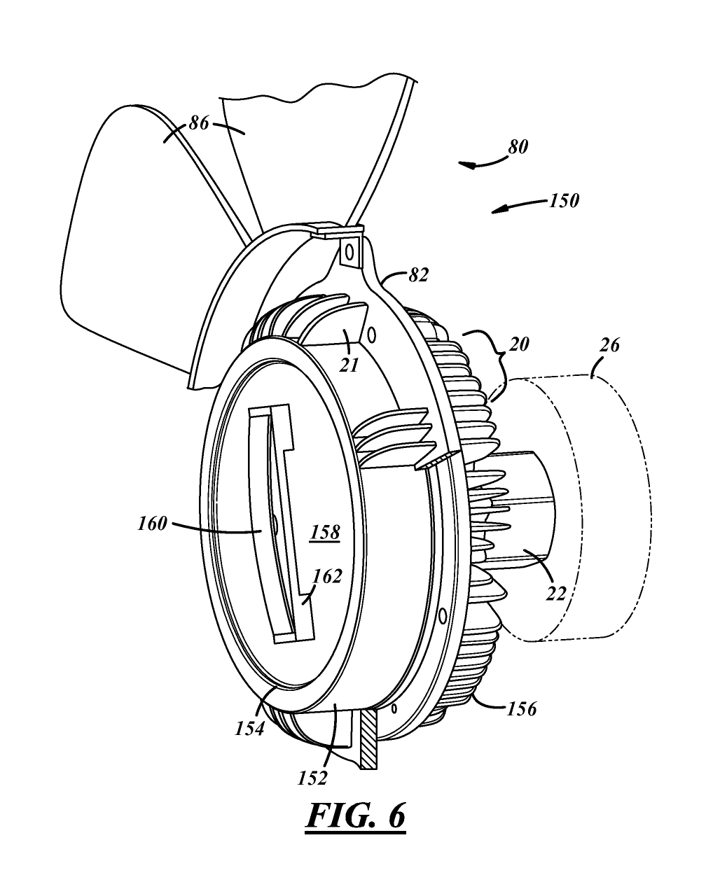

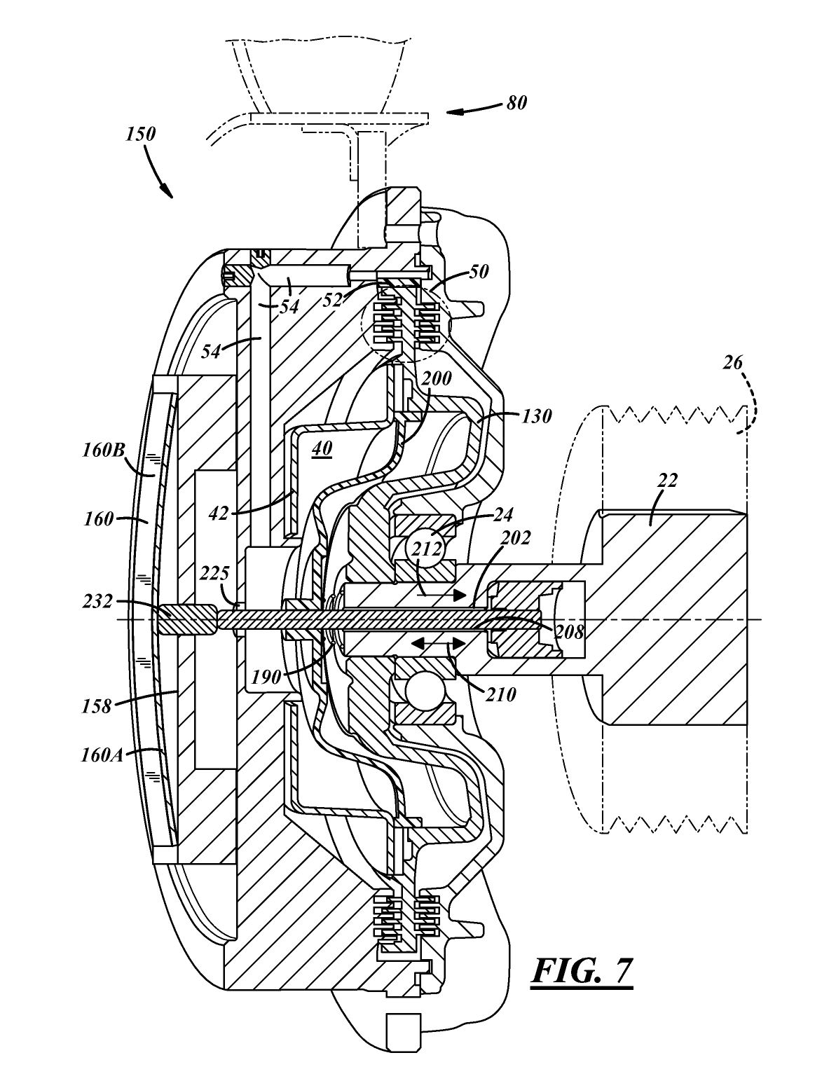

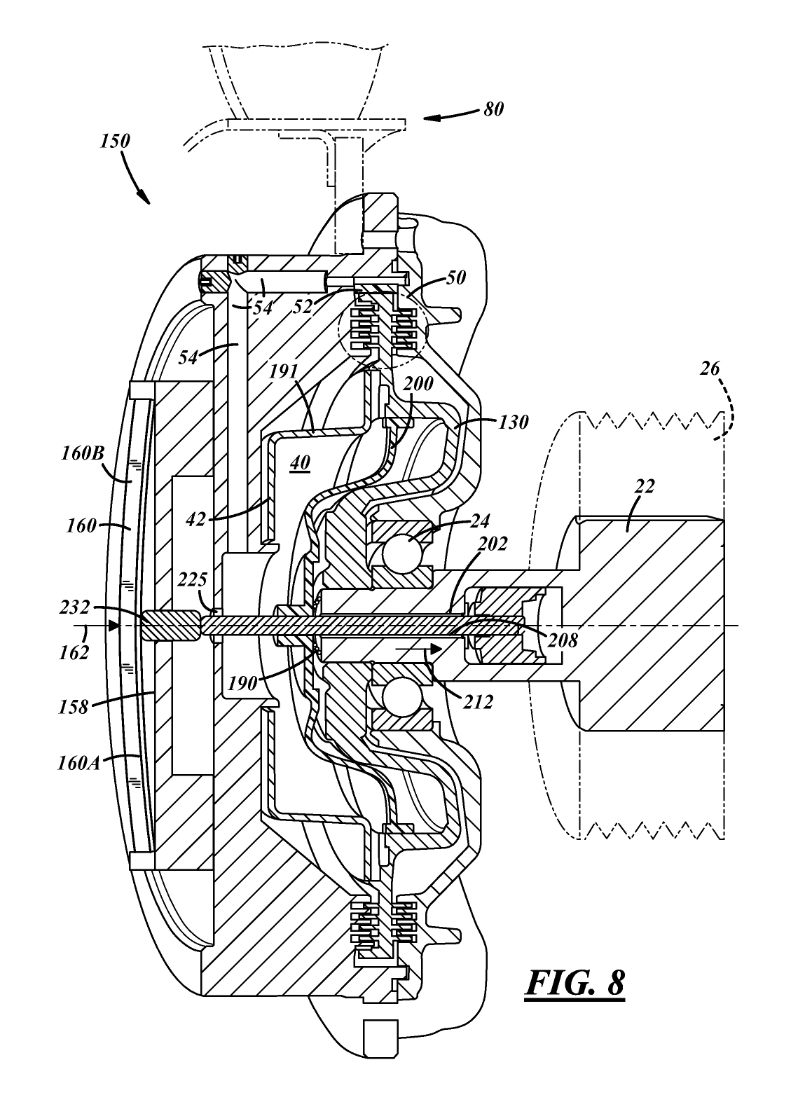

FIGS. 6-8 depict another embodiment 150 of the invention, with FIG. 6 being a perspective view of the viscous clutch fan drive member 150 and FIGS. 7 and 8 being a cross-section view thereof. This embodiment is similar to the embodiment of FIGS. 1-5 in that both utilize a bimetal member to activate a viscous fluid valve member and both have a viscous fluid reservoir that rotates at high (input) speed. Thus, both embodiments have similar benefits and advantages.

The FIG. 6-8 embodiment, however, differs from the FIG. 1-5 embodiment in that fan drive 150 includes a different bimetallic member and a different valve mechanism which is activated in a different way by the bimetal member. Other features of the viscous clutch fan drive which are common to these described above relate to FIGS. 1-5 are indicated by similar reference numbers.

The housing 152 includes a cover member 154 and a body member 156. A bimetal strip member 160 is attached to the outer surface 158 of the housing. The bimetal strip member is attached to a mounting member 162 which positions the strip member a short distance from the housing. The mounting member 162 is fixedly secured to the housing.

As shown in FIG. 6, the cover member 154 has a plurality of fin members 21 on the extended surface. Similar fin members 20 are positioned on the external surface of the body member 156. As indicated above, the fin members assist in dissipating heat from the viscous clutch.

A fan member 80 with a hub member 82 and plurality of fan blades 86 is attached to the housing similar to that described above with reference to FIGS. 1-5.

The bimetal strip member includes two layers 160A and 160B of two different metal materials, each with different coefficients of expansion. This is better shown in FIGS. 7 and 8. Layer 160A has a higher coefficient of expansion and expands more than the layer 160B. When heated, the bimetal strip member 160 curves downwardly toward the outer surface 158 of the housing member. This is shown in FIG. 8 and indicated by arrow 162.

A valve member 200 is positioned in the interior of the housing 152. The valve member is attached to a rod member 202 which is slidingly positioned in shaft member 22. The rod member 202 is positioned in a central bore or passageway 208 and slides inside the shaft member 22 as shown by arrow 210.

When the rod member 202 is moved in the directions indicated by arrow 210, the valve member 200 moves in the same directions. The movement of the valve member 200 opens and closes fluid ports 77 in the clutch disk member 130 which regulate the passage of viscous fluid to the working chamber 50. This is similar to the manner in which movement of the valve member 70 in the embodiment of FIGS. 1-5 opens and closes the fluid passageways, except the movement of the valve member 70 is rotary in FIGS. 1-5, while the movement of the valve member 200 in FIGS. 6-8 is axial.

Like the fan drive discussed above, the shaft member 22 is attached to a pulley member 26 and rotates at input speed. The clutch disk member 130 is attached to the shaft member 22 and rotates at the same speed. Similarly, the fluid reservoir 40 which is connected to the clutch disk member 130, rotates with the clutch disk at input speed. A carrier member from the valve member 200 (such as carrier member 76 discussed above) is not necessary in this embodiment, although one could be utilized if desired.

Similar to the viscous clutch embodiment described above, the working chamber 50 includes labyrinths on the outer portion of the clutch disk member 130 and mating labyrinths in the housing member. A wiper member 52 in the working chamber directs the viscous fluid exiting the working chamber into scavenge channel or passageway 54. The scavenged viscous fluid is directed into the viscous fluid reservoir chamber 40 formed by reservoir cover member 42. This is similar to the wiping and scavenge system discussed above with reference to FIGS. 1-5.

The valve member 200 is biased by spring member 190 in an axial direction toward the bimetal strip member 160. The spring member can be any type of conventional spring member, such as a curved washer, or coil spring, but preferably is a coaxial spring. A coaxial spring takes up less space axially when compressed.

The top end or head 232 of the rod member 202 is positioned in contact with the bimetal strip member 160, or a small distance from it. Preferably, the head 232 can rotate independently of the rod member 202. At this initial or “rest” position when fan cooling is not needed, the viscous fluid passageways to the working chamber are closed, and there is little viscous fluid in the working chamber.

Upon bending of the bimetal strip member 160 in a direction toward the outer surface 158 of the housing, the strip member 160 forces the rod member 202 in an axial direction toward the pulley member (in the direction of arrow 212 in FIGS. 7 and 8). This in turn moves the valve member in an axial direction and opens the ports 77 allowing viscous fluid to flow from reservoir chamber 40 into the working chamber 50. The valve member 200 is shown in the closed position in FIG. 7 and is shown in the open position in FIG. 8. The more the bimetal strip member bends, the more the ports 77 are opened, and the faster the fan member is rotated. As with the embodiment discussed above, the speed of the fan member can be changed infinitely from zero to full speed, depending on the heat being applied to the bimetal strip member and the resultant amount of bending.

Seal members, such as seal member 225, are provided to prevent leakage of the viscous fluid from the fan clutch drive.

The embodiments of FIGS. 1-5 and FIGS. 6-8 depict two types of bimetal actuated valves and valve mechanisms in accordance with the present invention for viscous clutch fan drives. These embodiments are not meant to be limiting, however. Other types and structures of valves and valve members can be utilized with the present invention.

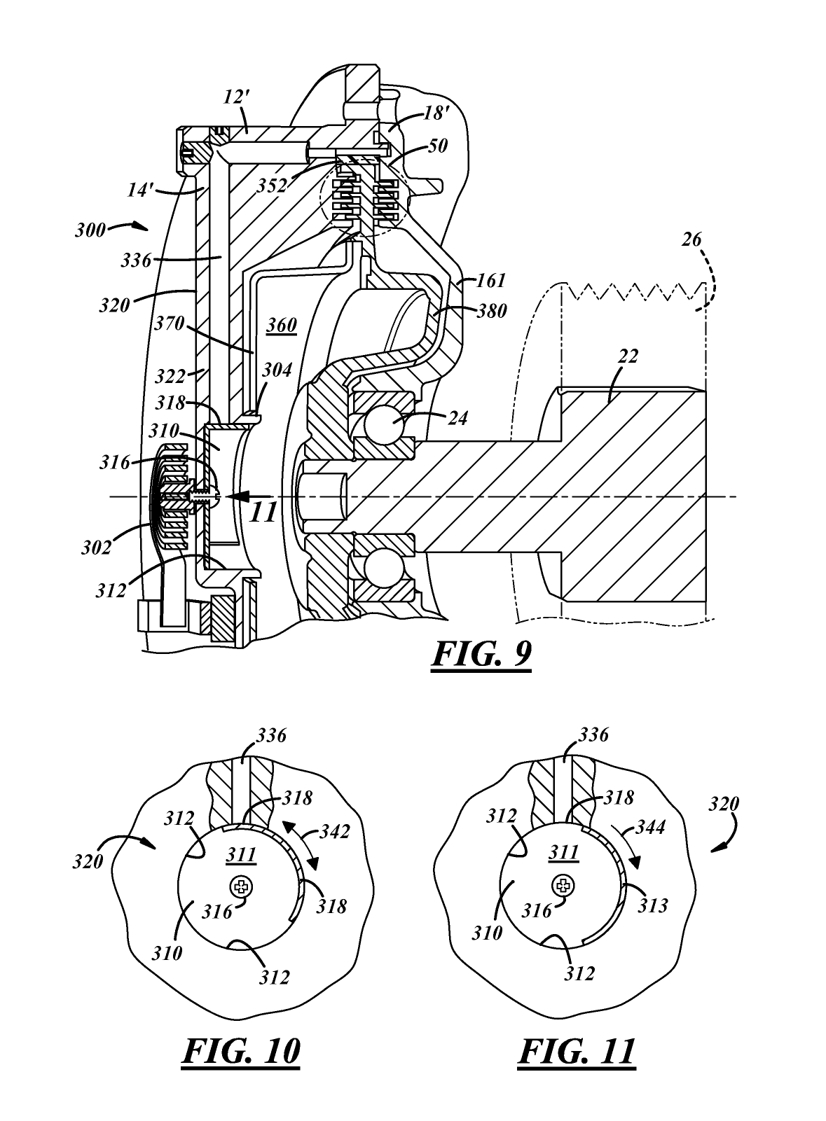

For example, one alternate valve mechanism for use with the present invention which utilizes a bimetal coil activation system, is shown in FIGS. 9-11. In this embodiment 300, a bimetal coil member 302, is connected to valve member 310 which is positioned in recess 312 in the inside of the cover member 320. The valve member 310 includes a flat circular base member 311 and a curved wall member 313. An opening or port member 318 is positioned in the wall of the recess 312 and is selectively covered and uncovered by rotation of the curved wall member 313. The valve member 310 rotates in the direction of the arrow 342 in FIG. 10.

The bimetal coil member 302 is positioned on the external surface 320 of the cover member 322 of the housing, and rotates with the cover member and housing when they rotate. The valve member 310 is positioned adjacent the port 318 which is the outlet port of the scavenge passageway 336. The scavenge passageway transports scavenged viscous fluid from the working chamber 50 through the cover member to the recess 312.

The recess 312 is in direct fluid communication with the viscous fluid reservoir cover 370 which forms the fluid reservoir 360, similar to the systems shown in the other embodiments discussed above. A central opening 364 in the fluid reservoir cover member 370 is directly adjacent to the recess 312. Scavenge fluid entering the recess 312 enters the fluid reservoir 360 where it can be returned to the working chamber 50 to rotate the fan blades and cool the vehicle engine.

Contraction or deformation of the bimetal coil member 302 due to thermal energy, causes the valve member 310 to rotate. The valve member 310 is connected to the bimetal coil member, such as by a screw-type fastener member 316. It can rotate in the two directions shown by arrow 342 in FIG. 10. The scavenge port 318 is closed in FIG. 10. When the bimetal coil is heated, the valve member rotates in the direction of arrow 344 in FIG. 11. This opens the scavenge port 318, as shown in FIG. 11.

The valve member thus can control the amount of fluid that can exit from the scavenge port and enter the fluid chamber 360 from 0% to 100%.

The fluid chamber cover member 370 is securely attached to the clutch disk member 380 and rotates with it at input speed. Thus the fluid chamber 360 rotates at input speed together with the clutch disk member 380 and the central shaft member 22.

The housing 12′ includes a cover member 14′ and a body member 16′ which are connected together at 18′ in a manner similar to the embodiments disclosed above. A fan member (not shown) similar to the fan members 80 disclosed above, is secured in the housing. The housing is positioned on the shaft member by bearing member 24 and rotates at fan speed. The operation of the viscous clutch is similar to the operations of the embodiments shown in the preceding Figures.

A wiper member 352 is positioned in the housing and used to wipe off viscous fluid from outer surface of the clutch disk member 380 and transfer it to the scavenge passageway 336. The wiper member 352 can be any type of conventional wiper member.

It is also possible to include a baffle member (not shown) in the fluid chamber 360 to assist in maintaining the viscous fluid in an effective state for passage into the working chamber 50. The baffle can have any shape and have openings and/or spokes as desired to allow passage of viscous fluid.

Appropriate sealing members should also be provided to prevent leakage of the viscous fluid from the cover member around the bimetal member.

Although the invention has been described with respect to preferred embodiments, it is to be also understood that it is not to be so limited since changes and modifications can be made therein which are within the full scope of this invention as detailed by the following claims.

What is claimed is:

1. A viscous clutch drive comprising:
a housing;
a rotatable clutch disk member positioned in said housing, said clutch disk member rotatable at input speed;
a working chamber comprising said housing and said clutch disk member;
a fluid reservoir positioned on said clutch disk member and rotatable therewith;
a valve member position in said fluid reservoir for selectively allowing viscous fluid to pass from said fluid reservoir to said working chamber; and
a bimetal strip member connected to said valve member;
wherein when said bimetal strip member is heated, it causes said valve member to allow passage of viscous fluid to said working chamber.

2. The viscous clutch drive described in claim 1 wherein said bimetal strip member axially moves said valve member to allow passage of viscous fluid to said working chamber.

3. The viscous clutch drive described in claim 1 further comprising a shaft member operably connected to said housing, and wherein said clutch disk member is fixedly attached to said shaft member.

4. The viscous clutch drive described in claim 3 wherein said housing is positioned on said shaft member by a bearing member.

5. The viscous clutch drive described in claim 1 wherein said valve member moves axially to selectively allow viscous fluid to pass from said fluid reservoir into said working chamber.

6. The viscous clutch drive described in claim 1 wherein said valve member rotates at input speed with said clutch disk member.

7. The viscous clutch drive described in claim 6 wherein said valve member moves axially independently of said clutch disk member when activated by said bimetal coil member.

8. A viscous clutch fan drive comprising:
a housing;
a fan member attached to said housing and axially moveable therewith;
a shaft member operably connected to said housing by a bearing member and connected to a pulley member for rotating at input speed;
a clutch disk member positioned in said housing and fixedly connected to said shaft member, wherein said clutch disk member is axially moveable at input speed;
a fluid chamber member in said housing forming a fluid reservoir, said fluid chamber member fixedly attached to said clutch disk member;
a working chamber comprising at least one shearing member on said housing and at least one mating shearing member on said clutch disk member;
a scavenge passageway in said housing for returning fluid from said working chamber to said fluid reservoir;
an axially moveable valve member positioned in said fluid reservoir, said axially moveable valve member being axially moveable by said shaft member;
a bimetal strip member positioned externally to said housing and connected internally to said valve member;
wherein thermal deformation of said bimetal strip member axially moves said valve member to regulate passage of fluid from said fluid reservoir to said working chamber.

9. The viscous clutch fan drive as described in claim 8 wherein said valve member comprises a central hub member, a plurality of arm members, and at least one annular flange member.

10. The viscous clutch fan drive as described in claim 8 wherein two shearing members are positioned in said housing and two mating shearing members are positioned on said clutch disk member.

11. The viscous clutch fan drive as described in claim 8 wherein said axially moveable valve member comprises a plurality of flange members, said flange members being positioned to open and close fluid passageways in said clutch disk member.

12. The viscous clutch fan drive as described in claim 8 wherein said axial movement of said valve member by said bimetal strip member is independent of said axial movement of said valve member by said shaft member.

13. The viscous clutch fan drive as described in claim 8 wherein said housing comprises a cover member and a body member.

14. A viscous clutch fan drive comprising:
a housing, said housing having a body member and a cover member;
a fan member attached to said housing and rotatable therewith;
a fluid working chamber in said housing for activating rotation of said fan member;
a shaft member positioned at least partially in said housing and connected to a pulley member for rotation at input speed
a clutch disk member positioned in said housing and fixedly connected to said shaft member, wherein said clutch disk member is rotatable at input speed;
said working chamber comprising at least one shearing member on said housing and at least one shearing member on said clutch disk member;
a fluid reservoir in said housing and connected to said clutch disk member and rotatable therewith;
a scavenge passageway in said housing for passing fluid from said working chamber to said fluid reservoir;
an axially moveable valve member positioned in said fluid reservoir for selectively allowing fluid to pass from said fluid reservoir to said working chamber;
a bimetal strip member positioned externally to said housing and connected internally to said valve member;
wherein thermal bending of said bimetal strip member causes said valve member to move axially and regulate the flow of fluid from said fluid reservoir to said working chamber.

15. The viscous clutch fan drive as described in claim 14 wherein said valve member comprises a central hub member, a plurality of arm members, and an annular flange member.

16. The viscous clutch fan drive as described in claim 14 wherein two shearing members are positioned on said housing and two mating shearing members are positioned on said clutch disk members.
